(19) United States
(12) Patent Application Publication
(10) Pub. No.: US 2022/0031430 A1
(43) Pub. Date: Feb. 3, 2022

(54) DENTAL IMPLANT AND SURGERY GUIDE THEREFOR

(71) Applicant: Dae Kyung LEE, Seongnam-si (KR)

(72) Inventor: Dae Kyung LEE, Seongnam-si (KR)

(21) Appl. No.: 17/401,748

(22) Filed: Aug. 13, 2021

Related U.S. Application Data
(63) Continuation of application No. PCT/KR2020/002110, filed on Feb. 14, 2020.

(30) Foreign Application Priority Data
Feb. 15, 2019 (KR) 10-2019-0017643
Feb. 14, 2020 (KR) 10-2020-0018052

(51) Int. Cl. A61C 8/00; A61C 13/08

(52) U.S. Cl. CPC A61C 8/0048; A61C 13/08

(57) ABSTRACT

The present disclosure provides an artificial tooth root for implantation of an artificial tooth. The artificial tooth root may include one or more body portions having a cylindrical shape, and an extension portion coupled to at least a portion of a lower portion of each of the one or more body portions and extending from a lower side and a side of the one or more body portions. The above body portions of the artificial tooth root may include a plurality of body portions, and by coupling the extension portion to the plurality of body portions, it is possible to couple a plurality of artificial tooth root implants through the extension portions.

### CROSS-REFERENCE TO RELATED APPLICATION

The present application is a continuation of International Patent Application No. PCT/KR2020/002110, filed Feb. 14, 2020, which is based upon and claims the benefit of priority to Korean Patent Application Nos. 10-2019-0017643 filed on Feb. 15, 2019 and 10-2020-0018052 filed on Feb. 14, 2020. The disclosure of the above-listed applications are hereby incorporated by reference herein in their entirety.

### TECHNICAL FIELD

The present disclosure relates to a dental implant and a surgical guide used for the dental implant, and more specifically, to an artificial dental implant and a surgical guide, which maintain a high load-bearing capacity once the artificial tooth is implanted, and which have a wide range of application for implantation.

### BACKGROUND

A dental implant is generally provided in such a form that includes a root-shaped artificial tooth root having a cylindrical body. However, since the artificial tooth root in this form requires that the cylindrical body having a certain length and diameter be placed into the alveolar bone, when the bone tissue is insufficient, it is difficult to place the dental implant to a sufficient depth. Therefore, when failed to be placed deeply enough, the implants often fall out because they cannot overcome the patients' occlusal force.

In addition, while the length of a dental implant body that can be placed in insufficient bone tissue is permitted up to 5 mm in the United States and 6 mm in Korea, there are many conditions that make it difficult to even place an implant body of this length. In addition, even when the implant body of this length is placed, the implant body may not be able to withstand the load during use and separated and removed from the bone tissue.

To solve this problem, bone grafting should be performed to generate a sufficient quantity of bone tissue before the implant body placement is performed. However, the bone grafting increases the difficulty and cost of the procedure, and there is a problem that the patient needs to wait for a long period of time until the osseous tissue is generated. In addition, even when the bone tissue is secured, the newly generated bone tissue could be insufficient or have insufficient strength, resulting in failed treatment. Dental implant treatment for patients with insufficient bone tissue remains a challenge. Recently, a method for utilizing scarce bone tissue to the utmost extent to place the dental implant is used, which utilizes the remaining bone tissue as much as possible by preparing a surgical guide incorporating digital technology ahead of the operation and performing the implantation operation to thus increase the accuracy of the operation. However, even in this case, the difficulty of placing a long implant body into areas generally having insufficient bone tissue is still not solved.

### SUMMARY

The present disclosure provides a dental implant and a surgical guide for solving the problems described above.

In addition, the present disclosure provides an artificial tooth root capable of withstanding external pressure and distributing impact force, which includes an extension portion extending from a lower side and a side of a cylindrical artificial tooth root, and in which the extension portion is connected with another cylindrical artificial tooth root or several other cylindrical artificial tooth roots at a predetermined distance.

In addition, the present disclosure provides a dental implant including one artificial tooth root including an extension portion and two or more artificial tooth roots connected to one another through the extension portion, which can provide a solid foundation even for patients with poor alveolar bone.

According to an embodiment of the present disclosure, an artificial tooth root for implantation of an artificial tooth is provided. The artificial tooth root may include one or more body portions having a cylindrical shape, and an extension portion coupled to at least a portion of a lower portion of each of the one or more body portions and extending from a lower side and a side of the one or more body portions.

According to another embodiment of the present disclosure, an artificial tooth root for implantation of an artificial tooth is provided. The artificial tooth root may include one or more body portions having a cylindrical shape, and an extension portion coupled to at least a portion of a lower portion of each of the one or more body portions. In addition, when the one or more body portions and the extension portion are coupled, the extension portion may form a structure extending from lower sides and sides of the body portions.

According to yet another embodiment of the present disclosure, an artificial tooth root for implantation of artificial teeth may include one or more body portions having a cylindrical shape, two or more first extension portions coupled to at least a portion of a lower portion of each of the one or more body portions, and two second extension portions coupled to one ends of the two or more first extension portions. In addition, when the one or more body portions, the two or more first extension portions, and the two second extension portions are coupled, the first extension portions and the second extension portions may form a structure extending from lower sides and sides of the body portions.

According to various embodiments of the present disclosure, with the dental implant including the artificial tooth root, the abutment, and the artificial tooth, the lower end of the artificial tooth root extends in a direction perpendicular to the longitudinal direction of the artificial tooth root or laterally, so that the artificial tooth root and the alveolar bone can contact with each other over a larger area, thereby increasing the retention of the dental implant in the bone tissue. Therefore, it is possible to ensure a stable implant in a small quantity of bone tissue in the vertical direction.

In addition, with a plurality of dental implants according to various embodiments of the present disclosure, since the artificial tooth roots are connected to each other through the edges extending on both sides, the retention force of the dental implant can be further increased as compared to a plurality of dental implants including the related artificial tooth root.

In addition, according to various embodiments of the present disclosure, when the vertical length of the artificial tooth root and the extension portion of the dental implant is shortened, the depth of the groove formed in the alveolar bone for insertion of the artificial tooth root can be made shallower than that of the related one, thereby allowing artificial dental implantation even for patients with the alveolar bone of shallow depth or thin thickness.

In addition, according to various embodiments of the present disclosure, since the thickness of the plurality of artificial tooth roots and extension portions can be made thinner than the thickness of the related dental implant, artificial dental implantation is possible even for patients with a small width of alveolar bone in the area in need of procedure or for an incisor generally having a small width of the alveolar bone.

The effects of the present disclosure are not limited to the effects described above, and other effects that are not mentioned above can be clearly understood to those skilled in the art based on the description provided below.

### BRIEF DESCRIPTION OF THE DRAWINGS

Embodiments of the present invention will be described, by way of example only, and with reference to the following drawings.

FIG. 1 is a cross-sectional view illustrating a dental implant according to an embodiment of the present disclosure.

FIGS. 2A to 2C are perspective views illustrating the shape of an artificial tooth root according to various embodiments of the present disclosure.

FIGS. 3A and 3B are perspective views illustrating the artificial tooth root and an abutment in disassembled and coupled states according to an embodiment of the present disclosure.

FIGS. 4 to 9 show a front view, a plan view, and a side view illustrating an artificial tooth root with a plurality of body portions coupled by an extension portion according to various embodiments of the present disclosure.

FIGS. 10A to 10F are front views illustrating an artificial tooth root in which one body portion is coupled to an extension portion according to various embodiments of the present disclosure.

FIG. 11 is a perspective view and a front view illustrating an artificial tooth root in which one body portion is coupled to an extension portion according to another embodiment of the present disclosure.

FIGS. 12A and 12B are views illustrating a surgical guide for the placement of an artificial tooth root according to an embodiment of the present disclosure.

FIG. 13 is a view illustrating a surgical guide for the placement of an artificial tooth root according to another embodiment of the present disclosure.

FIGS. 14 to 16 are views illustrating shapes of an artificial tooth root according to another embodiment of the present disclosure.

FIGS. 17A to 17C are plan views illustrating various shapes of an artificial tooth root according to another embodiment of the present disclosure.

FIGS. 18A and 18B are perspective views illustrating various shapes of an artificial tooth root according to yet another embodiment of the present disclosure.

FIG. 19 is a view illustrating the shape of an artificial tooth root according to yet another embodiment of the present disclosure.

FIGS. 20A to 20C are views illustrating a surgical guide for the placement of an artificial tooth root according to another embodiment of the present disclosure.

FIG. 21 is a view illustrating a surgical guide for the placement of an artificial tooth root according to yet another embodiment of the present disclosure.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

It should be noted that in the drawings, like components or parts may be represented by like reference numerals, if possible. In describing the present disclosure, when a detailed description about a related well-known art may obscure the gist of the present disclosure, the detailed description thereof will not be provided.

In the accompanying drawings, like or relevant components may be indicated by like reference numerals. In the following description of the embodiments, repeated descriptions of the identical or relevant components may be omitted. However, even if a description of a component is omitted, such a component is not intended to be excluded in an embodiment.

Hereinafter, the terms used in the present disclosure will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in specific cases, the term may be arbitrarily selected by the applicant, and the meaning of the term will be described in detail in a corresponding description of the embodiments. Therefore the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms.

Further, throughout the description, when a portion is stated as “comprising (including)” an element, it intends to mean that the portion may additionally comprise (or include or have) another element, rather than excluding the same, unless specified to the contrary.

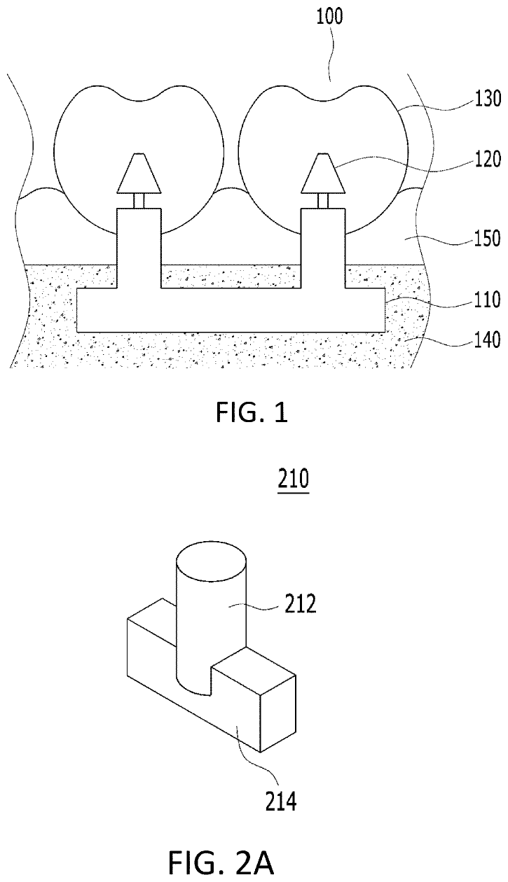

FIG. 1 is a cross-sectional view illustrating a dental implant according to an embodiment of the present disclosure. FIG. 1 is a cross-sectional view illustrating the dental implant placed into alveolar bone and gums according to the present embodiment.

As illustrated, a dental implant 100 includes an artificial tooth root 110 (fixture), an abutment (abutment) 120, and an artificial tooth 130 (crown).

For the placement of the dental implant 100, as will be described in detail below, a gum 150 may be cut, thus exposing an alveolar bone 140 to the outside such that a groove in the longitudinal direction may be formed in an upper portion of the exposed alveolar bone 140, into which the artificial tooth root 110 is to be inserted. The artificial tooth root 110 may be inserted into the groove formed in the alveolar bone 140 and firmly fixed. The artificial tooth root 110 fixed to the alveolar bone 140 is coupled with the abutment 120. In addition, the artificial tooth 130 may be fabricated in a shape similar to that of a natural tooth that is to be replaced by the dental implant 100, and may be coupled in a form that closely surrounds the upper portions of the abutment 120 and the artificial tooth root 110. After the dental implant 100 is inserted into the alveolar bone 140, a gap between the alveolar bone 140 and the artificial tooth root 110 may be filled through a bone graft, or over time, the gap between the alveolar bone 140 and the artificial tooth root 110 may be filled by the growth of the surrounding alveolar bone 140. In addition, the gum 150 that was cut for the procedure of the dental implant 100 eventually wraps around the upper portion of the artificial tooth root 110 and a lower portion of the artificial tooth 130 by suturing procedure and/or natural healing.

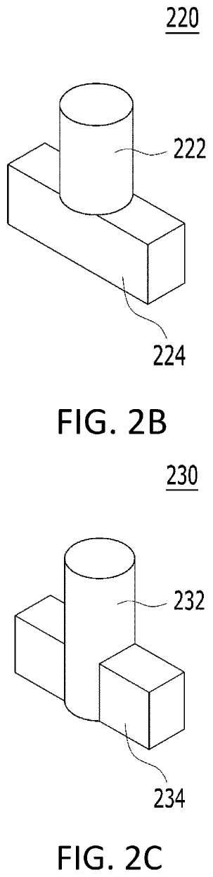

FIGS. 2A to 2C are perspective views illustrating the shape of the artificial tooth root 110 according to various embodiments of the present disclosure.

As illustrated in FIG. 2A, an artificial tooth root 210 may include a body portion 212 having an approximately cylindrical shape, and an extension portion 214 located at a lower end of the body portion 212 and having an approximately plate shape extending from the lower and/or side portions of the body portion 212. The extension portion 214 may be configured to extend to both sides of the body portion 212 in a direction perpendicular to the longitudinal direction of the body portion 212, and may have a substantially uniform thickness in its longitudinal direction.

In an embodiment, the body portion 212 and the extension portion 214 of the artificial tooth root 210 may be integrally formed using substantially the same material. In another embodiment, the body portion 212 of the artificial tooth root 210 may be fabricated in a state of being separated from the extension portion 214, and may be coupled to the extension portion 214.

The extension portion 214 may be formed to be smaller in thickness than a diameter of the cylindrical shape of the body portion 212. Since the extension portion 214 is formed to have the approximately plate shape and is formed to have a thin thickness, as illustrated in FIG. 1, it can be easily inserted into a site of thin alveolar bone 140.

In addition, the extension portion 214 may be formed with a height in a range of about 2 mm to about 3 mm. In this case, the artificial tooth root 210 may be formed to be shallower than about 6 mm which is the depth by which the related artificial tooth root is inserted into the groove of the alveolar bone. As described above, the artificial tooth root 210 including the extension portion 214 having the low height may be inserted into a site where the alveolar bone 140 is resorbed or thinned, by making a groove in that site. As described above, when the artificial tooth root 210 is provided with the extension portion 214 extending in the direction perpendicular to the longitudinal direction of the body portion 212, after the placement of the dental implant including the artificial tooth root 210, the impact force is dispersed throughout the longitudinal direction of the extension portion 214 when masticating or receiving an impact from the outside, such that the retention of the dental implant is improved.

In an embodiment, while the extension portion 214 of the artificial tooth root 210 is located in the lower portion of the body portion 212, as illustrated in FIG. 2A, the lower portion of the body portion 212 and the upper portion of the extension portion 214 may be configured in a partially overlapping form. In another embodiment, as illustrated in FIG. 2B, a body portion 222 of an artificial tooth root 220 may be configured to be in vertical contact with an extension portion 224. In another embodiment, as illustrated in FIG. 2C, an extension portion 234 of an artificial tooth root 230 may be configured to completely overlap with a body portion 232 vertically.

Additionally, a plurality of grooves may be formed on at least one surface of the body portion 212, 222, and 232 and the extension portion 214, 224, and 234 of the artificial tooth root 210, 220, and 230. The shape of the groove formed on the surface of the artificial tooth root 210, 220, and 230 may be any one of a round shape, a wedge shape, an uneven shape, and the like, but is not limited thereto. For example, the surface of the artificial tooth root 210, 220, and 230 may be subjected to a surface roughening treatment as applied to the related artificial tooth root. The grooves formed on the surface of the artificial tooth root 210, 220, and 230 may have the effect of expanding the surface area of the artificial tooth root 210, 220, and 230 in contact with the alveolar bone, and also have the effect of increasing the strength of the dental implant by increasing the surface roughness.

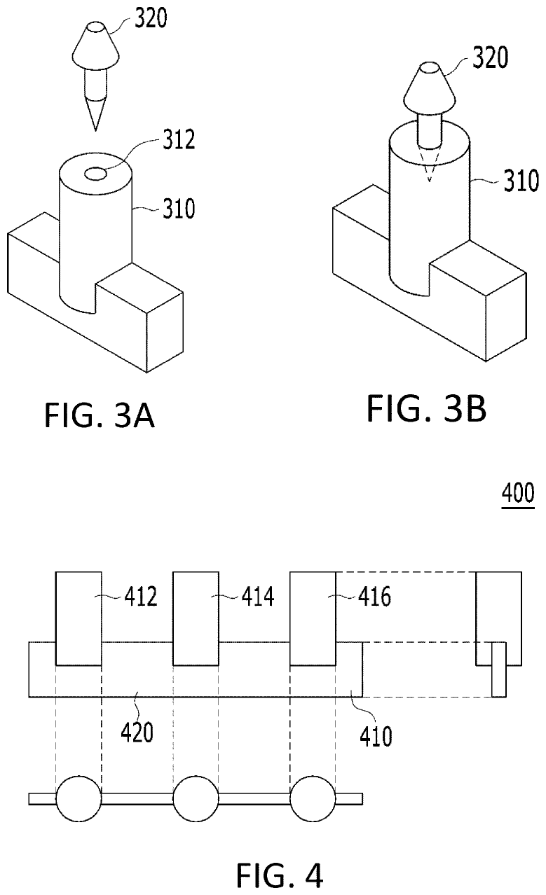

FIGS. 3A and 3B are perspective views illustrating the artificial tooth root 110 and the abutment 120 according to an embodiment of the present disclosure.

As illustrated in FIG. 3A on the left-hand side, on an upper surface of an artificial tooth root 310, a groove 312 may be provided, into which a lower portion of an abutment 320 can be inserted and coupled. In addition, the lower portion of the abutment 320 may have a screw shape that can be inserted into and coupled to the upper groove of the artificial tooth root 310, although the shape of the lower portion of the abutment 320 is not limited thereto. For example, various related coupling methods may be used for coupling the lower portion of the abutment 320 with the upper portion of the artificial tooth root 110. In addition, the upper portion of the abutment 320 may have an approximately triangular pyramid shape that allows the artificial teeth to cover and be attached to the same. As illustrated in FIG. 3B on the right-hand side, the abutment 320 may be inserted into the groove formed on the upper surface of the artificial tooth root 310 and fixedly coupled.

FIGS. 4 to 9 show a front view, a plan view, and a side view illustrating an artificial tooth root with a plurality of body portions coupled to the extension portion according to various embodiments of the present disclosure.

FIGS. 4 to 9 illustrate shapes of artificial tooth roots 400 to 900 in which three body portions are coupled to the extension portion, but the shape of the artificial tooth root according to the present disclosure is not limited thereto, and may have a shape in which two or four or more body portions are coupled to the extension portion.

As illustrated, the artificial tooth roots 400 to 900 may include body portions corresponding in number to the artificial teethes 130 to be implanted, and may include an extension portion extending in a direction perpendicular to the longitudinal direction of the body portions at lower portions of the body portions. The extension portion may be connected to each body portion, so that each body portion and the extension portion may be integrally coupled. Hereinafter, embodiments of an artificial tooth root having various forms of a plurality of body portions and the extension portion will be described in detail with reference to FIGS. 4 to 9.

As illustrated in FIG. 4, the artificial tooth root 400 may include an extension portion 420 integrally coupled to three body portions 412, 414, and 416, and wing portions 410 located on both ends of the extension portion 420. The wing portions 410 may be formed to extend further from the body portions 412, 414, and 416 in a transverse direction. As illustrated, the extension portion 420 may be configured to partially overlap the body portions 412, 414, and 416. That is, in an artificial tooth root 500, the upper portion of the extension portion 420 may be overlappingly coupled to the lower portions of the body portions 412, 414, and 416.

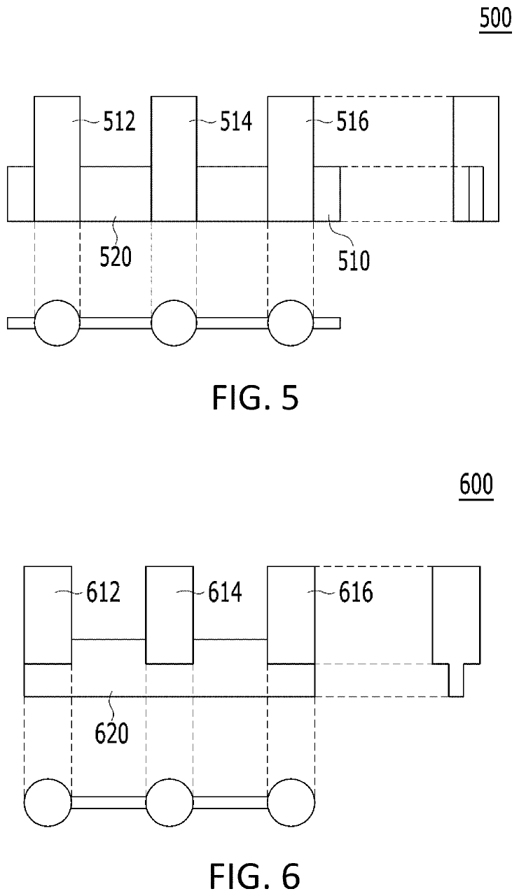

As illustrated in FIG. 5, the artificial tooth root 500 may include an extension portion 520 integrally coupled to three body portions 512, 514, and 516, and wing portions 510 located on both ends of the extension portion 520. The wing portions 510 may be formed to extend further from the body portions 512, 514, and 516 in a transverse direction. In addition, as illustrated, the extension portion 520 may be configured to completely overlap with the body portions 512, 514, and 516. That is, the artificial tooth root 500 may be configured such that the sides of the extension portion 520 are coupled to the lower portions of the body portions as a whole, between two adjacent body portions of the body portions 512, 514, and 516.

As illustrated in FIG. 6, wing portions may not be formed on both ends of an extension portion 620 of an artificial tooth root 600. That is, the extension portion 620 may be formed to extend from a left side of a body portion 612 of the artificial tooth root 600 where the first artificial tooth on the left side of the drawing is to be located, to a right side of a body portion 616 of the artificial tooth root 600 where the third artificial tooth is to be located.

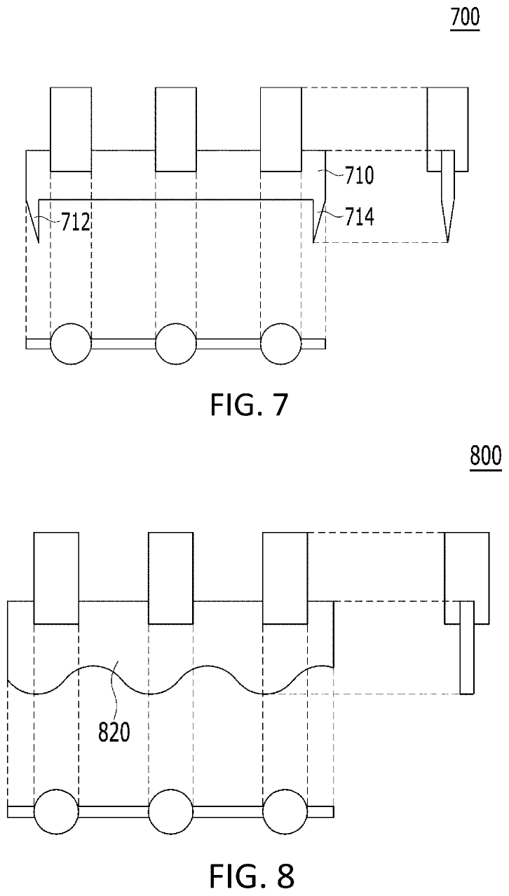

As illustrated in FIG. 7, wing portions 710 of an artificial tooth root 700 may further include protrusions 712 and 714 extending downwardly from lower portions of both ends of the wing portions 710. The artificial tooth root 700 further including the protrusions 712 and 714 has a form similar to the root of a natural tooth and therefore, it provides the effect of increased surface area in contact with the alveolar bone 140, thereby enabling a more robust coupling with the alveolar bone 140. In one example, the protrusions 712 and 714 extending in the vertical direction may be integrally formed with the wing portions 710. In another example, the protrusions 712 and 714 may be fabricated separately from the wing portions 710, and additionally fixed through a female screw hole formed in the wing portion 710.

As illustrated in FIG. 8, a lower portion of an extension portion 820 of an artificial tooth root 800 may have a curved surface rather than a uniform cross section. As illustrated, the extension portion 820 may have a wavy surface, but is not limited thereto, and may also have an angled uneven surface, a wedge-shaped surface, and the like. As described above, when the lower portion of the extension portion 820 is formed to have a curved surface rather than a smooth cross section, the surface area where the artificial tooth root 800 and the alveolar bone 140 come into contact with each other increases, allowing firmer coupling with the alveolar bone 140.

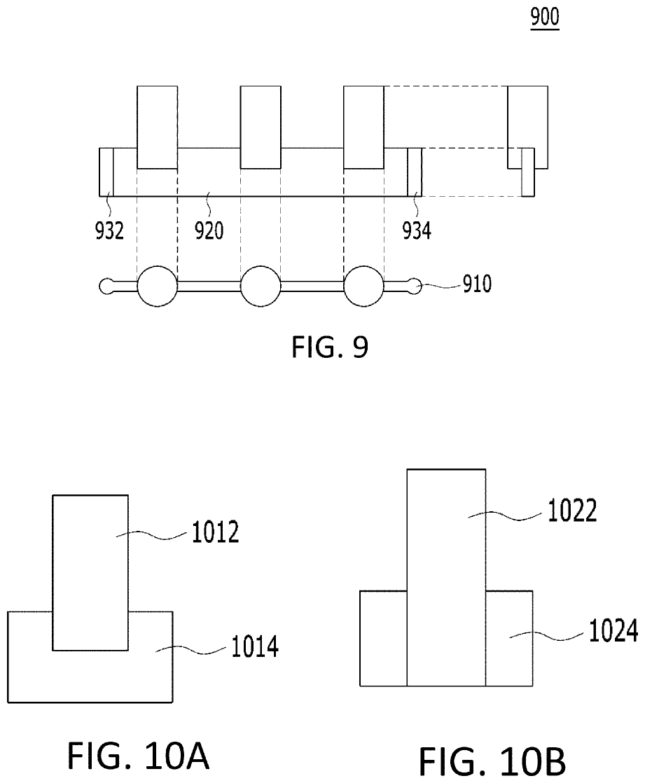

As illustrated in FIG. 9, wing portions 910 of an artificial tooth root 900 may further include protrusions 932 and 934 formed to have a thickness greater than the thickness of an extension portion 920. As illustrated in FIG. 9, the protrusions 932 and 934 may have a shape in which cylindrical pillars are attached to both ends of the extension portion 920, but is not limited thereto, and may also have a shape in which rectangular pillars or polygonal pillars are attached to both ends of the extension portion 920. The protrusions 932 and 934 formed on both ends of the extension portion 920 increase the surface area where the artificial tooth root 900 and the alveolar bone 140 come into contact with each other, and serve to more strongly fix the artificial tooth root 900 in a transverse direction of the alveolar bone 140.

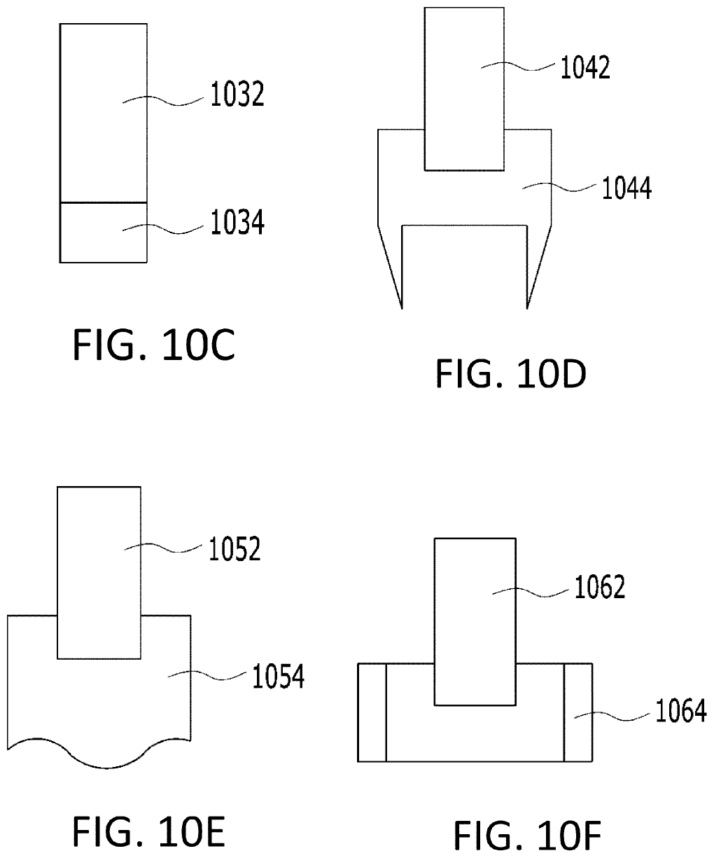

FIGS. 10A to 10F are front views illustrating a shape of an artificial tooth root according to various embodiments of the present disclosure.

The various shapes of the extension portion of the artificial tooth root described above with reference to FIGS. 4 to 9 may also be applied to one artificial tooth root as illustrated in FIGS. 10A to 10F, thus providing the effect of increased coupling between the implant body and the alveolar bone.

As illustrated in FIG. 10A, it may configured in such a form that sides and a lower side of a lower portion of a body portion 1012 are coupled with at least a portion of an upper portion of an extension portion 1014, or as illustrated in FIG. 10B, it may configured in such a form that sides of a lower portion of a body portion 1022 are coupled with a middle portion of an extension portion 1024, or as illustrated in FIG. 10C, it may configured in such a form that a lower side of a lower portion of a body portion 1032 is coupled with an upper portion of an extension portion 1034.

In addition, as illustrated in FIG. 10D, an extension portion 1044 (or wing portion) of the artificial tooth root may further include protrusions extending downwardly from lower portions of both ends of the wing portion, or as illustrated in FIG. 10E, a lower portion of an extension portion 1054 of the artificial tooth root may have a curved surface rather than a uniform cross section. As illustrated in FIG. 10F, a wing portion 1064 of the artificial tooth root may further include protrusions formed to have a thickness greater than the thickness of the extension portion.

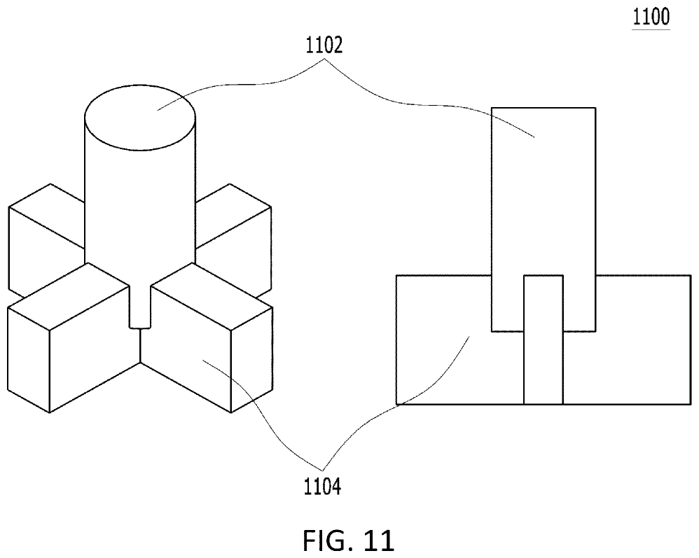

FIG. 11 shows a perspective view and a front view illustrating the shape of an artificial tooth root according to another embodiment of the present disclosure.

As illustrated, the artificial tooth root 1100 may include four extension portions 1104 coupled to a side and a lower side of a body portion 1102 of the artificial tooth root, from four different directions of the side of the body portion 1102. As described above, the shape of the extension portions coupled to the body portion 1102 of the artificial tooth root 1100 is not limited to that illustrated in FIG. 11, and may have various shapes of the extension portions as illustrated in FIGS. 10A to 10F.

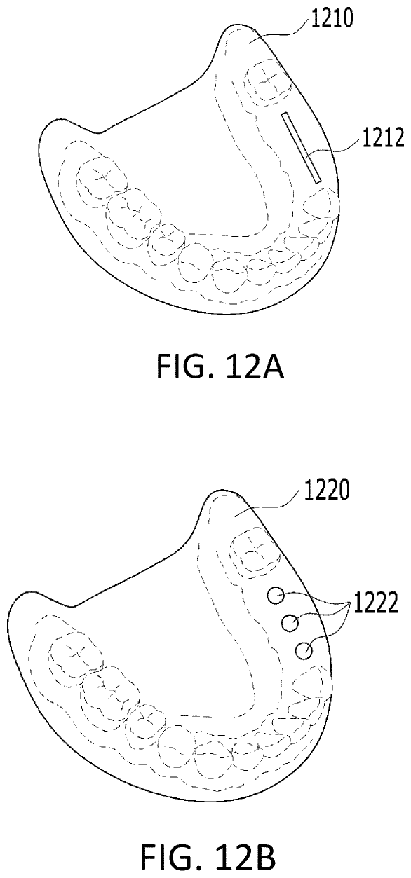

FIGS. 12A and 12B are views illustrating a surgical guide for the placement of an artificial tooth root according to an embodiment of the present disclosure.

According to an embodiment, the artificial tooth root (e.g., 110, 210, 220, 230, and 400 to 900) used in the dental implant 100 may be fabricated by a milling method of cutting a titanium mass, or 3D printing. In addition, the position and shape of the artificial tooth root to be placed into the alveolar bone may be appropriately determined according to the shape of the remaining bone tissue and the position of the existing tooth by precisely checking the bone condition of a targeted site of placement through 3D X-ray computed tomography of the face.

In addition, in order to determine the position, direction and depth of insertion of the artificial tooth root into the alveolar bone, a model of the teeth and gums may be prepared using materials such as alginate, polyvinylsiloxane, polysulfide, and the like. By making a plaster model with a negative mold, the shape of an area requiring dental implantation can be identified. In addition, by scanning the plaster model or directly scanning the patient's oral cavity and matching the resultant data with the 3D X-ray computed tomography information, it is possible to accurately check, on a screen providing information obtained by 3D X-ray computed tomography, the area where the extension portions of the artificial tooth root and the body portions are to be inserted and fixed according to the present disclosure.

When the plaster model of the tooth is completed, a surgical guide 1210 and 1220 for use in the placement procedure of the artificial tooth root can be fabricated by 3D printing method based on the plaster model.

The surgical guide 1210 includes a groove 1212 formed in an area on the alveolar bone corresponding to the extension portion of the artificial tooth root to be inserted into the alveolar bone of the area for dental implantation, for guiding an operating direction of a surgical tool (e.g., a laser cutting tool) that forms a groove corresponding to the longitudinal shape of the extension portion.

After the groove for receiving the extension portion of the artificial tooth root to be inserted therein is formed on the alveolar bone of the area for dental implantation with the surgical guide 1220, another surgical guide 1222 may be used to form a groove for receiving the lower portion of the body portion of the artificial tooth root to be inserted therein. That is, the surgical guide 1220 includes the groove 1222 formed on the alveolar bone of the area for dental implantation, for guiding the operating direction of the surgical tool that forms the lower portion of the body portion connected to the extension portion of the artificial tooth root.

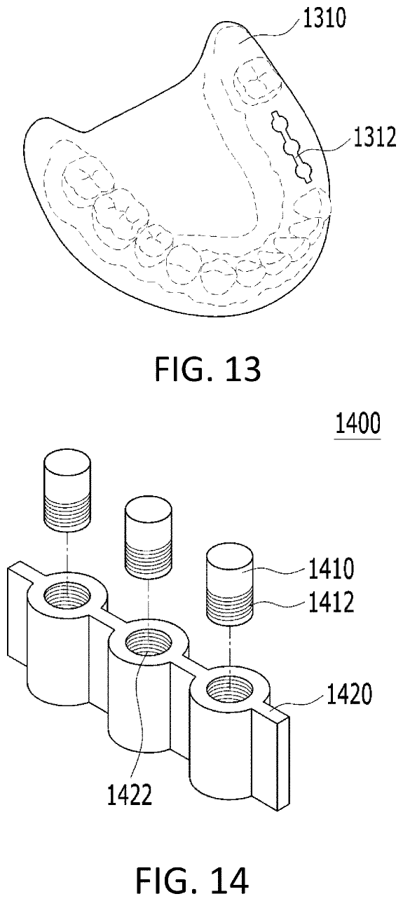

FIG. 13 is a view illustrating a surgical guide for the placement of an artificial tooth root according to another embodiment of the present disclosure.

Similarly to the steps described above with reference to FIGS. 12A and 12B, when the plaster model of the tooth is completed, a surgical guide 1310 for use in the placement procedure of the artificial tooth root can be fabricated by 3D printing method based on the plaster model.

The surgical guide 1310 includes a groove 312 formed in an area on the alveolar bone corresponding to the extension portion of the artificial tooth root to be inserted into the alveolar bone of the area for dental implantation, for guiding an operating direction of a surgical tool (e.g., a laser cutting tool) that forms a groove corresponding to the longitudinal shape of the extension portion.

As described above, after the groove for receiving the extension portion of the artificial tooth root to be inserted therein is formed on the alveolar bone of the area for dental implantation by using the groove 1312 of the surgical guide 1310, the same groove 1312 may be used to form a groove for receiving the lower portion of the body portion of the artificial tooth root to be inserted therein.

FIGS. 14 to 16 are views illustrating various shapes of an artificial tooth root according to another embodiment of the present disclosure.

As illustrated in FIG. 14, an extension portion 1420 and a body portion 1420 of an artificial tooth root 1400 may be fabricated separately. After the extension portion 1420 is inserted into the groove formed in the alveolar bone by the surgical guide 1310 illustrated in FIG. 13, for example, the extension portion 1420 and the body portion 1410 may be coupled to each other.

In an embodiment, the coupling between an opening 1422 of the extension portion 1420 and a lower portion 1412 of the body portion 1410 may be achieved by coupling a female thread formed on an inner surface of the opening 1422 and a male thread formed on a side of the lower portion 1412 of the body portion to each other. In another embodiment, the coupling of the extension portion 1420 and the body portion 1410 may be performed by wedge driving method or interference fitting method.

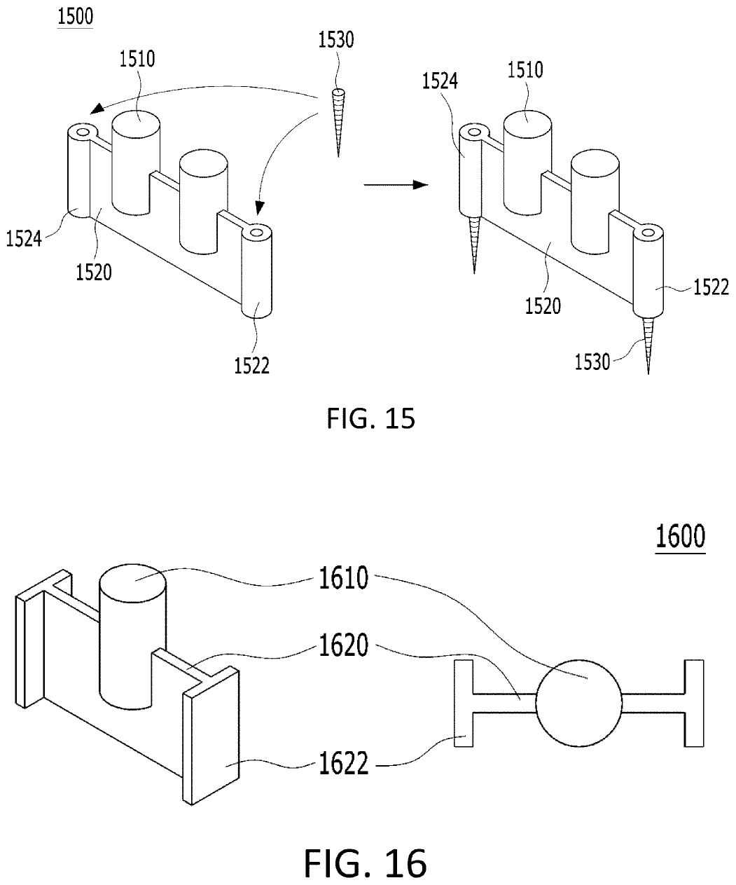

As illustrated in FIG. 15, wing portions on both sides, which are extended from sides of an extension portion 1520 of an artificial tooth root 1500, may further include first protrusions 1522 and 1524 formed with a thickness greater than the thickness of the extension portion 1520. Openings are formed in the centers of the first protrusions 1522 and 1524 in the longitudinal direction, and second protrusions 1530 in the form of a screw extending in the vertical direction may be coupled to the openings of the first protrusions 1522 and 1524. The method for coupling the first protrusions 1522 and 1524 and the second protrusion 1530 may include coupling by screw tightening, coupling by wedge driving, or coupling by interference fitting. The length of the second protrusion 1530 is formed to be longer than the height of the extension portion 1520, so that the implant body can be more stably fixed when the artificial tooth root 1500 is coupled with the alveolar bone.

In addition, as illustrated in FIG. 16, the wing portion of an artificial tooth root 1600 may further include protrusions 1622 protruding in a direction perpendicular to both ends of an extension portion 1620 coupled to the side and lower sides of a body portion 1610. Although FIG. 16 illustrates the shape of the protrusion 1622 additionally formed at the end of the extension portion 1620 as an approximately rectangular shape in cross section, the shape of the protrusion 1622 is not limited thereto, and may include various other shapes. By including various types of protrusions in the wing portion, the artificial tooth root 1600 can be stably fixed when the implant body is coupled with the alveolar bone.

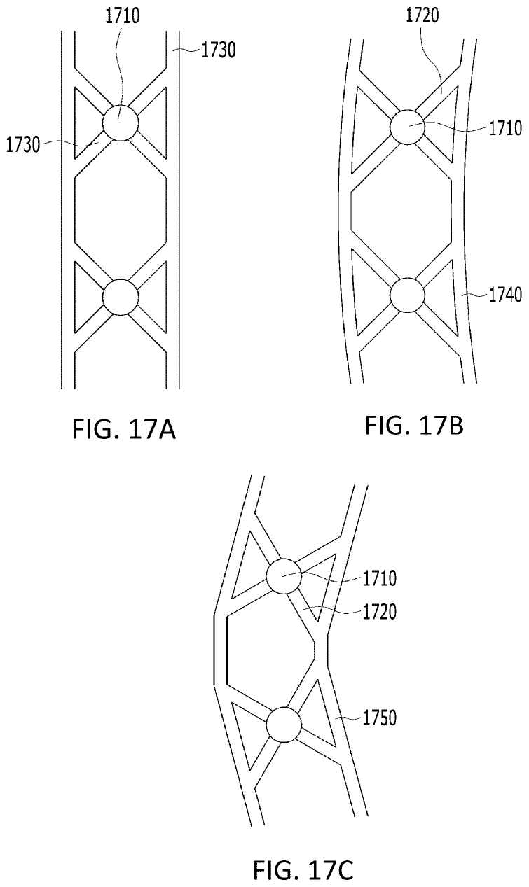

FIGS. 17A to 17C are plan views illustrating various shapes of an artificial tooth root according to another embodiment of the present disclosure.

As illustrated in FIG. 17A, the artificial tooth root according to the present embodiment includes body portions 1710 having an approximately cylindrical shape, first extension portions 1720 having an approximately plate shape and extending in four different directions from the body portions 1710, and second extension portions 1730 having an approximately plate shape and connecting one ends of the first extension portions 1720. The artificial tooth root configured as described above has an approximately straight or curved shape so as to be suitable for the structure of the dental dentition and the gingival bone of the area into which the corresponding artificial tooth root is to be placed.

The shell region of the alveolar bone into which the artificial tooth root is to be placed is usually covered with hard cortical bone, and the inside thereof has a honeycomb or loofah structure, although there are individual differences. In general, the alveolar bone of the upper jaw is thinner than the alveolar bone of the lower jaw and the internal structure thereof is also less dense. In addition, the alveolar bone with molar teeth is less dense than the alveolar bone in the region with incisors. Therefore, the alveolar bone in the upper jaw or region with molar teeth has the most unfavorable condition for artificial tooth root procedure in terms of bone density. The shape of the artificial tooth root illustrated in FIGS. 17A to 17C has a structure that is more suitable for procedure on the alveolar bone which has an unfavorable condition for the procedure of the artificial tooth root as described above. That is, since an external shock or load applied to the body portions 1710 of the artificial tooth root can be distributed to the first extension portions 1720 extending in four different directions and the second extension portions 1730, the procedure for the artificial tooth root can be stably and firmly performed even in the alveolar bone region with low bone density.

FIGS. 17B and 17C illustrate the shapes of the artificial tooth root formed to conform to the shape (approximately curved shape) of the alveolar bone of the lower jaw or the upper jaw. Specifically, as illustrated in FIG. 17B, the artificial tooth root according to the another embodiment includes the body portions 1710, the first extension portions 1720 having an approximately plate shape extending in four different directions from the body portions 1710, and second extension portions 1740 having an approximately curved plate shape and connecting one ends of the first extension portions 1720. In addition, as illustrated in FIG. 17C, the artificial tooth root according to yet another embodiment includes the body portions 1710, the first extension portions 1720 having an approximately plate shape and extending in four different directions from the body portions 1710, and second extension portion 1750 having a plate shape bent at any angle and connecting one ends of the first extension portions 1720.

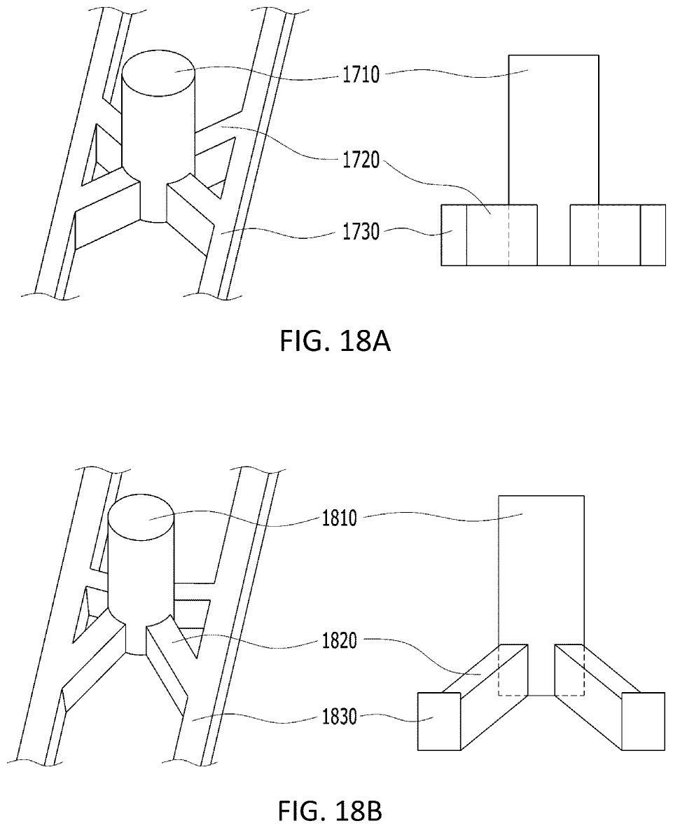

FIGS. 18A and 18B are perspective views illustrating various shapes of an artificial tooth root according to yet another embodiment of the present disclosure.

FIG. 18A is a perspective view illustrating the shape of the artificial tooth root illustrated in FIG. 17A. As illustrated, the artificial tooth root includes the body portion 1710 having an approximately cylindrical shape, the first extension portions 1720 located on a lower end of the body portion 1710 and having an approximately plate shape and extending from a portion of a side of the body portion 1710, and the second extension portions 1730 having an approximately plate shape and connecting one ends of the first extension portions 1720.

The first extension portions 1720 may be configured to extend in four directions from the body portion 1710 in a direction perpendicular to the longitudinal direction of the body portion 1710, and may have a substantially uniform thickness in the longitudinal direction. In addition, the second extension portion 1730 may also have a substantially uniform thickness in its longitudinal direction.

In an embodiment, the body portion 1710, the first extension portions 1720, and the second extension portions 1730 of the artificial tooth root may be integrally formed using substantially the same material. In another embodiment, the body portion 1710 of the artificial tooth root may also be fabricated in a state of being separated from the first extension portions 1720 and the second extension portions 1730, and then coupled to the first extension portions 1720 and the second extension portions 1730.

The first extension portions 1720 and the second extension portions 1730 may be formed to have a thickness smaller than a diameter of the cylindrical shape of the body portion 1710. In addition, the first extension portions 1720 and the second extension portions 1730 may be formed to have a height in a range of about 2 mm to about 3 mm.

As illustrated in FIG. 18A, the first extension portions 1720 of the artificial tooth root may be configured to completely overlap with the body portion 1710 vertically, but is not limited thereto, and the first extension portions 1720 of the artificial tooth root may be coupled to the body portion 1710 in various forms. In an embodiment, while the first extension portions 1720 are located on the lower portion of the body portion 1710, as illustrated in FIG. 2A, the lower portion of the body portion 1710 and the upper portion of the first extension portions 1720 may also be configured to partially overlap with each other. In another embodiment, as illustrated in FIG. 2B, the body portion 1710 may be configured to be in vertical contact with the first extension portion 1720.

FIG. 18A illustrates the shape of the artificial tooth root in which four first extension portions 1720 formed on the side of the body portion 1710 are formed in the direction perpendicular to the body portion 1710, but the artificial tooth root according to the present disclosure is not limited thereto, and the four first extension portions 1720 formed on the side of the body portion 1710 may be formed at an angle a with respect to the side of the body portion 1710, which may be changed within a range of about 90°<α<180°.

FIG. 18B is a perspective view illustrating the shape of an artificial tooth root according to another embodiment of the present disclosure. As illustrated, the artificial tooth root includes a body portion 1810 having an approximately cylindrical shape, first extension portions 1820 located on a lower end of the body portion 1810 and having an approximately plate shape and extending from a portion of a side of the body portion 1810 downward at an oblique angle, and second extension portions 1830 having an approximately plate shape and connecting one ends of the first extension portions 1820.

The artificial tooth root having the configuration illustrated in FIG. 18B can be stably fixed even when there is difficulty in performing the implant procedure due to the round shape of the alveolar bone or the thin thickness of the alveolar bone as in the case of the upper jaw. For example, the procedure may be performed in such a way that lower portions or portions of the second extension portion 1830 and the first extension portion 1820 of the artificial tooth root are inserted into a lower surface of the alveolar bone, and a lower portion or a portion of the body portion 1810 is inserted into a higher surface of the alveolar bone.

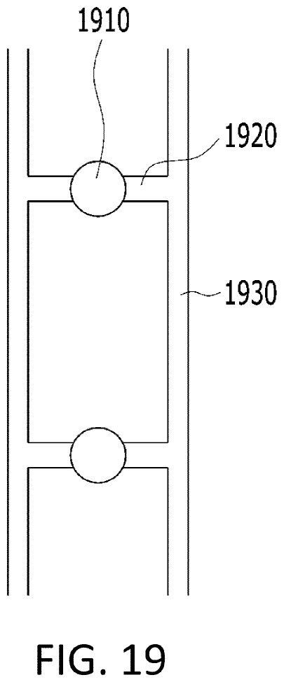

FIG. 19 is a plan view illustrating the shape of an artificial tooth root according to yet another embodiment of the present disclosure.

As illustrated in FIG. 19, the artificial tooth root according to the present embodiment includes body portions 1910 having an approximately cylindrical shape, first extension portions 1920 having an approximately plate shape and extending in two different directions from the body portions 1910, and second extension portions 1930 having an approximately plate shape and connecting one ends of the first extension portions 1920. The artificial tooth root configured as described above has an approximately straight or curved shape so as to be suitable for the structure of the dental dentition and the gingival bone of the area into which the corresponding artificial tooth root is to be placed.

Compared with the shapes of the artificial tooth root illustrated in FIGS. 17A to 18B, the shape of the artificial tooth root illustrated in FIG. 19 has a configuration including two first extension portions 1920 extending from both sides of the body portion 1910. An artificial tooth root having such structural characteristics may be more suitable for the placement into the alveolar bone having a relatively high bone density. For example, for the lower jaw having a higher bone density than the upper jaw, it may be possible to place an artificial tooth root having a relatively simple structure. Therefore, for the alveolar bone of the lower jaw, it may be more preferable to place the artificial tooth root illustrated in FIG. 19 rather than the artificial tooth root illustrated in FIGS. 17A to 18B.

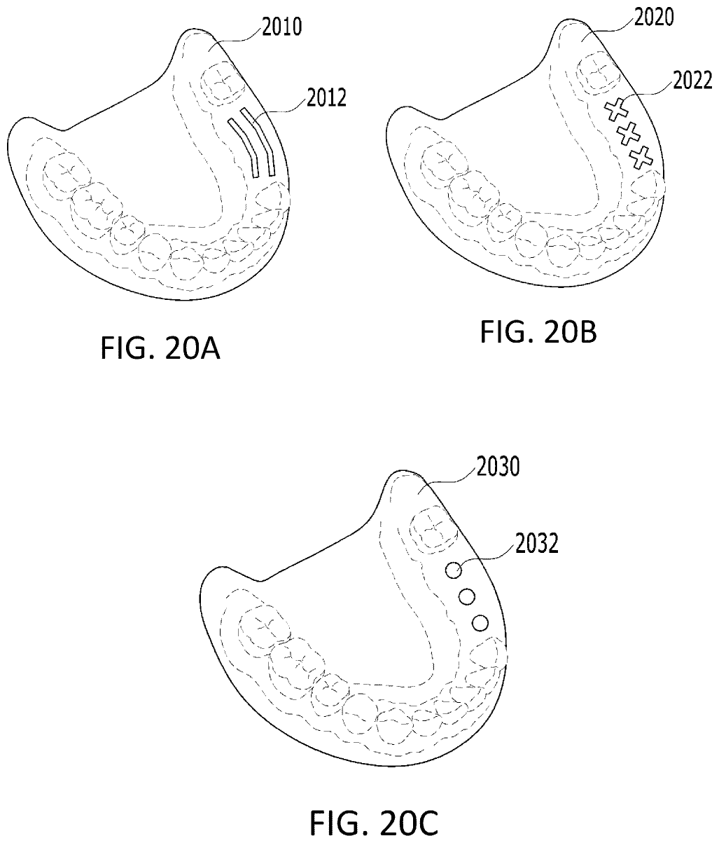

FIGS. 20A to 20C are views illustrating a surgical guide for the placement of an artificial tooth root according to another embodiment of the present disclosure.

Similarly to the embodiment described above with reference to FIGS. 12 and 13, the artificial tooth root (e.g., the artificial root illustrated in FIGS. 17A to 19) used in the dental implant 100 may be fabricated by a milling method of cutting a titanium mass or by 3D printing method. In addition, the position and shape of the artificial tooth root to be placed into the alveolar bone may be appropriately determined according to the shape of the remaining bone tissue and the position of the existing tooth by precisely checking the bone condition of a targeted site of placement through 3D X-ray computed tomography of the face. In addition, in order to determine the position, direction and depth of insertion of the artificial tooth root into the alveolar bone, a model of the teeth and gums may be prepared using materials such as alginate, polyvinylsiloxane, polysulfide, and the like. By making a plaster model with a negative mold, the shape of an area requiring dental implantation can be identified. In addition, by scanning the plaster model or directly scanning the patient's oral cavity and matching the resultant data with the 3D X-ray computed tomography information, it is possible to accurately check, on a screen providing information obtained by 3D X-ray computed tomography, the area where the extension portions of the artificial tooth root and the body portions are to be inserted and fixed according to the present disclosure.

When the plaster model of the tooth is completed, a surgical guide 2010, 2020 and 2030 for use in the placement procedure of the artificial tooth root can be fabricated by 3D printing method based on the plaster model.

As illustrated in FIG. 20A, the surgical guide 2010 includes two grooves 2012 in areas on the alveolar bone which correspond to the second extension portions of the artificial tooth root to be inserted into the alveolar bone of the area for dental implantation, for guiding an operating direction of a surgical tool (e.g., a laser cutting tool) that forms grooves corresponding to the longitudinal shape of the second extension portions.

After the grooves for receiving the second extension portions of the artificial tooth root to be inserted therein are formed on the alveolar bone of the area for dental implantation with the surgical guide 2010, another surgical guide 2020 may be used to form grooves for receiving the first extension portions of the artificial tooth root to be inserted therein. The surgical guide 2020 includes approximately cross-shaped grooves 2022 formed in an area on the alveolar bone corresponding to the first extension portions of the artificial tooth root to be inserted into the alveolar bone of the area for dental implantation, for guiding an operating direction of a surgical tool that forms grooves corresponding to the cross-shape (or straight-shape) of the first extension portions.

Next, a groove for receiving the body portion of the artificial tooth root to be inserted therein may be formed by using yet another surgical guide 2030. That is, the surgical guide 2030 includes groove 2032 formed on the alveolar bone of the area for dental implantation, for guiding the operating direction of the surgical tool that forms the lower portions of the body portions connected to the first extension portions of the artificial tooth root.

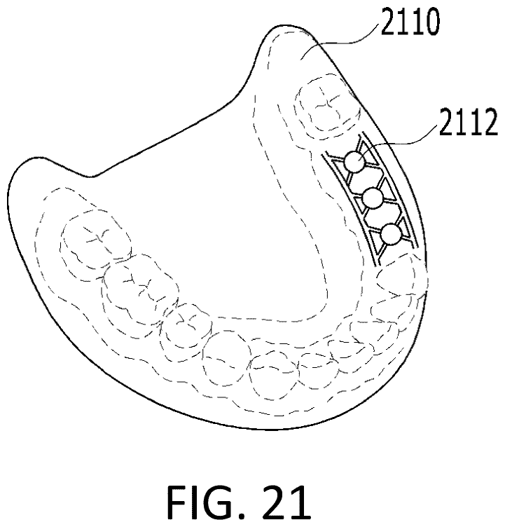

FIG. 21 is a view illustrating a surgical guide for the placement of an artificial tooth root according to yet another embodiment of the present disclosure.

Similarly to the steps described above with reference to FIGS. 20A to 20C, when the plaster model of the tooth is completed, a surgical guide 2110 for use in the placement procedure of the artificial tooth root can be fabricated by 3D printing method based on the plaster model.

The surgical guide 2110 includes grooves 2112 formed in areas on the alveolar bone corresponding to the first and second extension portions of the artificial tooth root to be inserted into the alveolar bone of the area for dental implantation, for guiding the operating direction of a surgical tool (e.g., a laser cutting tool) that forms grooves corresponding to the shapes of the corresponding extension portions.

As described above, after the grooves for receiving the first and second extension portions of the artificial tooth root to be inserted therein are formed on the alveolar bone of the area for dental implantation by using the grooves 2112 of the surgical guide 2110, the same groove 2112 may be used to form grooves for receiving the lower portions of the body portions of the artificial tooth root to be inserted therein.

Although the present disclosure has been described in connection with some embodiments herein, it should be understood that various modifications and changes can be made without departing from the scope of the present disclosure, which can be understood by those skilled in the art to which the present disclosure pertains. Further, such modifications and changes are intended to fall within the scope of the claims appended herein.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. In addition, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An artificial tooth root for implantation of an artificial tooth, comprising:
one or more body portions having a cylindrical shape;
an extension portion coupled to at least a portion of a lower portion of each of the one or more body portions and extending from a lower side and a side of the one or more body portions.

2. The artificial tooth root according to claim 1, further comprising wing portions extending from sides of both ends of the extension portion in a longitudinal direction.

3. The artificial tooth root according to claim 1, further comprising protrusions extending from lower sides of both ends of the extension portion in a longitudinal direction.

4. The artificial tooth root according to claim 1, further comprising first protrusions formed on both ends of the extension portion in a longitudinal direction, and having a thickness greater than a thickness of the extension portion.

5. The artificial tooth root according to claim 4, wherein the first protrusions include openings formed in a longitudinal direction, and
the artificial tooth root further includes second protrusions to be inserted and coupled in the openings.

6. The artificial tooth root according to claim 1, wherein a plurality of grooves are formed on a surface of at least one of the body portion and the extension portion.

7. The artificial tooth root according to claim 1, wherein the one or more body portions include a plurality of body portions, and
the extension portion is coupled to at least a portion of a lower portion of each of the plurality of body portions to be integrated with the plurality of body portions.

8. An artificial tooth root for implantation of an artificial tooth, comprising:
one or more body portions having a cylindrical shape; and
an extension portion coupled to at least a portion of a lower portion of each of the one or more body portions,
wherein, when the one or more body portions and the extension portion are coupled, the extension portion forms a structure extending from lower sides and sides of the body portions.

9. An artificial tooth root for implantation of an artificial tooth, comprising:
one or more body portions having a cylindrical shape;
two or more first extension portions coupled to at least a portion of a lower portion of each of the one or more body portions; and
two second extension portions coupled to one ends of the two or more first extension portions,
wherein, when the one or more body portions, the two or more first extension portions, and the two second extension portions are coupled, the first extension portions and the second extension portions form a structure extending from lower sides and sides of the body portions.

10. The artificial tooth root according to claim 9, wherein the first extension portions extend from a portion of the sides of the body portions at an oblique angle in a downward direction of the body portions.
